(19) United States
(12) Patent Application Publication
(10) Pub. No.: US 2005/0211665 A1
(43) Pub. Date: Sep. 29, 2005

(54) Methods of forming a microlens array

(75) Inventors: Wei Gao, Vancouver, WA (US); Yoshi Ono, Camas, WA (US); John F. Conley JR., Camas, WA (US)

Correspondence Address: DAVID C RIPMA, PATENT COUNSEL;SHARP LABORATORIES OF AMERICA, 5750 NW PACIFIC RIM BLVD, CAMAS, WA, 98607, US

(73) Assignee: Sharp Laboratories of America, Inc.

(21) Appl. No.: 10/813,789

(22) Filed: Mar. 26, 2004

(51) Int. Cl. B29D 11/00

(52) U.S. Cl. 216/26

(57) ABSTRACT

Methods of forming microlens structure are provided. A hard mask is formed overlying a transparent material. An opening is patterned into the hard mask. Both the patterned hard mask and the underlying transparent material are exposed to a wet etch that etches the hard mask and the transparent material. As the hard mask is etched the opening increases exposing more of the transparent material. Depending on the etch selectivity, a lens shape is formed with sloped sidewalls. The lens opening may be filled with lens material to form a lens.

### BACKGROUND OF THE INVENTION

The present method relates to methods of forming microlens structures and microlens arrays.

### BRIEF DESCRIPTION OF THE DRAWINGS

FIG. 1 is a cross sectional view of a microlens structure overlying a substrate.

FIG. 2 is a cross-sectional view of an intermediate microlens structure overlying a substrate.

FIG. 3 is a cross-sectional view of an intermediate microlens structure overlying a substrate.

FIG. 4 is a cross-sectional view of an intermediate microlens structure overlying a substrate.

FIG. 5 is a cross-sectional view of an intermediate microlens structure overlying a substrate.

FIG. 6 is a cross-sectional view of an intermediate microlens structure overlying a substrate.

FIG. 7 is a cross-sectional view of an intermediate microlens structure overlying a substrate.

FIG. 8 is a cross-sectional view of an intermediate microlens structure overlying a substrate.

FIG. 9 is a cross-sectional view of a microlens structure overlying a substrate.

FIG. 10 is a cross-sectional view of a microlens structure overlying a substrate.

FIG. 11 is a cross-sectional view of a microlens structure overlying a substrate.

FIG. 12 is a cross-sectional view of an intermediate microlens structure overlying a substrate.

FIG. 13 is a cross-sectional view of a microlens array structure overlying a substrate.

FIG. 14 is a top view of a mircolens array structure overlying a substrate.

FIG. 15 is a cross-sectional view of an intermediate microlens structure overlying a substrate.

FIG. 16 is a cross-sectional view of an intermediate microlens structure overlying a substrate.

FIG. 17 is an SEM image of a microlens structure.

FIG. 18 is an SEM image of a microlens array structure.

### DETAILED DESCRIPTION OF THE INVENTION

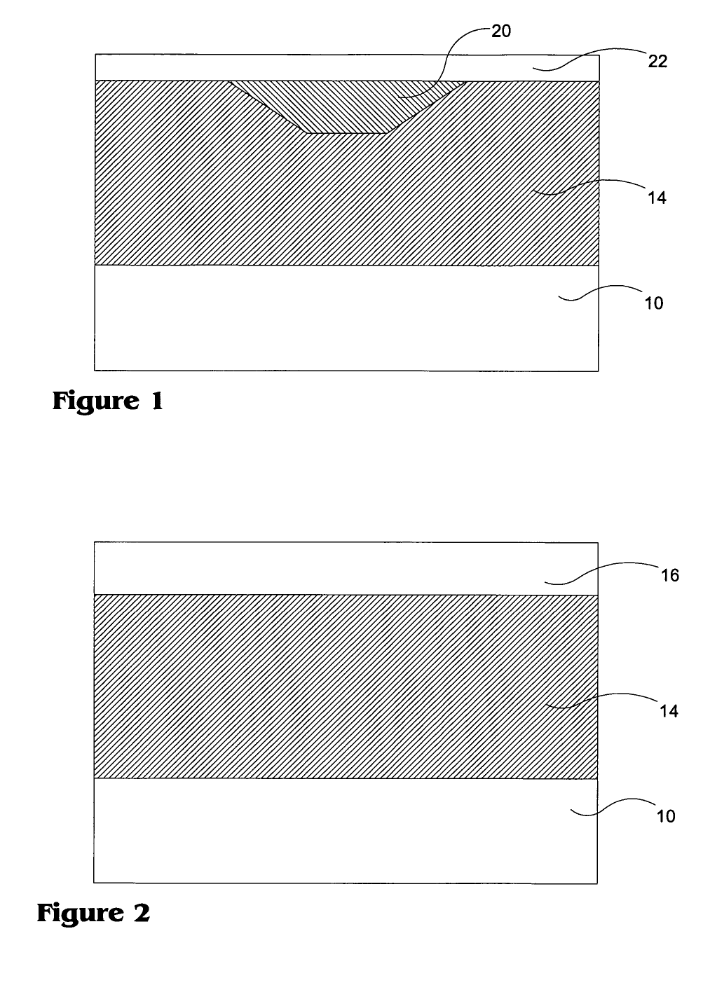

FIG. 1 shows an embodiment of a microlens structure formed according to an embodiment of the present method. A transparent layer 14 has been deposited overlying a substrate 10. An anti-reflection layer 22 is formed overlying the microlens 20. The thickness of the transparent layer 14 will be determined, in part, based on the desired lens curvature and focal length considerations.

FIG. 2 shows the substrate 10 after a transparent layer 14 is formed overlying the substrate. A hard mask 16 has been formed overlying the transparent layer 14.

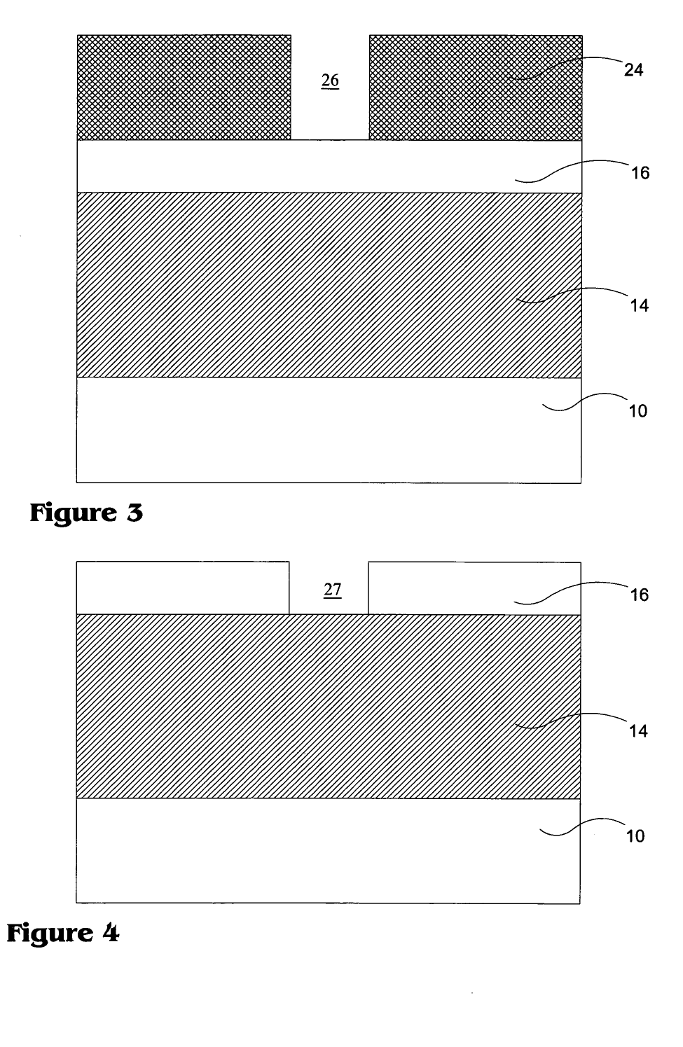

FIG. 3 shows a layer of photoresist 24 deposited overlying the hard mask 16. As shown, an opening 26 has been patterned into the photoresist. The opening 26 will be used to pattern the hard mask 16. The opening 26 will be smaller than the desired lens size. The opening 26 may have any desired shape that will be patterned into the hard mask 16.

The hard mask 16 is etched using an anisotropic etch, for example a dry etch using a fluorocarbon such as C₃F₈ with argon, stopping at approximately the transparent layer 14 to form an opening 27, as shown in FIG. 4. Note that stopping slightly before or partially into the transparent layer may be tolerable in some embodiments. While not stopping exactly at that transparent layer may affect the resulting lens dimensions, this may be within process tolerance. The layer of photoresist 24 is then stripped. The hard mask 16 has an opening 27. The opening 27 may have any desired shape, however, FIG. 4 only shows the cross-section. In one embodiment, the opening 27 is circular with a diameter (r) and a hard mask thickness (t).

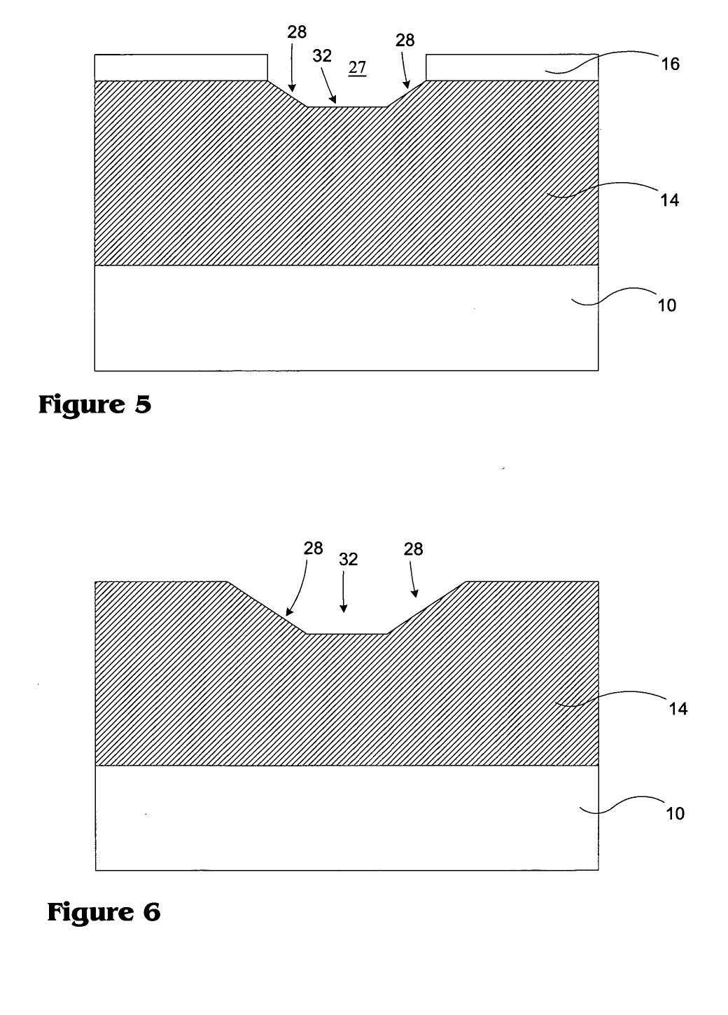

Once the opening 27 has been formed in the hard mask 16, an isotropic wet etch is used to form a lens shape 32 as shown in FIG. 5. For example, if glass or silicon oxide are used as the hard mask or the transparent layer, a buffered HF etch may be used. The hard mask 16 is consumed over time during the isotropic wet etch, both vertically and laterally. This makes the opening 27 bigger as the etching continues. The hard mask 16 has an etch rate (a), while the transparent layer 14 has an etch rate (b). The lens shape 32 will be determined by the etch ratio (s=a/b). The etch ratio (s) determines the slope of the sidewalls 28. In an embodiment of the present method, the hard mask 16 and the transparent layer 14 are selected such that the etch ratio is greater than 1, which means that the hard mask etches s times faster than the transparent layer.

In an embodiment of the present method, the transparent layer 14 is a thermal oxide, and the hard mask 16 is a TEOS oxide. As used herein, the term silicon oxide refers generally to any form of silicon oxide, or silicon dioxide, whether formed using thermal oxidation, CVD or sputtering. The properties of silicon oxide may vary depending on the method of forming the oxide layer. Thermal oxide refers to a silicon oxide material formed by thermal oxidation of a deposited silicon layer or a silicon substrate. TEOS oxide refers to a silicon oxide that is deposited using a CVD method with a TEOS precursor. TEOS oxide has an etch rate approximately 3 times greater than thermal oxide when using a buffered HF wet etch, so that the etch ratio s of TEOS oxide to thermal oxide is 3. This will produce a lens shape 32 with sloped sidewalls 28.

In another embodiment of the present method, the hard mask 16 is formed using the same basic material as that used to form the transparent layer 14, only the hard mask is doped to modify its etch rate. For example, if TEOS oxide is doped with phosphorous, it will have a faster etch rate than undoped TEOS oxide. Doping may also be used to fine tune the etch ratio when two different materials are used. For example, if TEOS oxide is doped with boron, it will have a slower etch rate than undoped TEOS oxide. In this way the etch ratio of a TEOS oxide hard mask overlying a thermal oxide may also be adjusted.

In another embodiment, transparent organic materials such as optical quality organic resins, may be used to form the transparent layer and or the hard mask. These materials may be selected such that an isotropic wet etch is available that will etch both the transparent layer and the hard mask, but at different etch rates.

In an embodiment of the present invention, when the hard mask 16 has been completely consumed during etching, the etch is stopped, as shown in FIG. 6. The thickness of the hard mask 16 is calculated so that by the end of the wet etch, the lens shape 32 will have approximately the desired dimensions. The lens diameter (D) equals two times the hard mask thickness (t) plus the diameter of the opening (r), so that D=2*t+r. The thickness of the lens (d) equals the hard mask thickness (t) divided by the etch selectivity (s), so that d=t/s. Due to the nature of wet etch processes, the lens shape 32 will probably have rounded corners, which are not undesirable and may be preferred.

The thickness of the transparent layer 14 will be determined, in part, based on the desired lens curvature and focal length considerations, as well as the amount of etching caused by the isotropic wet etch. In one embodiment of the present microlens structure, the desired focal length of the microlenses 20 is between approximately 2 μm and 8 μm. The thickness of the transparent layer 14 as deposited should be thick enough to achieve the desired focal length distance following all etching and planarization steps.

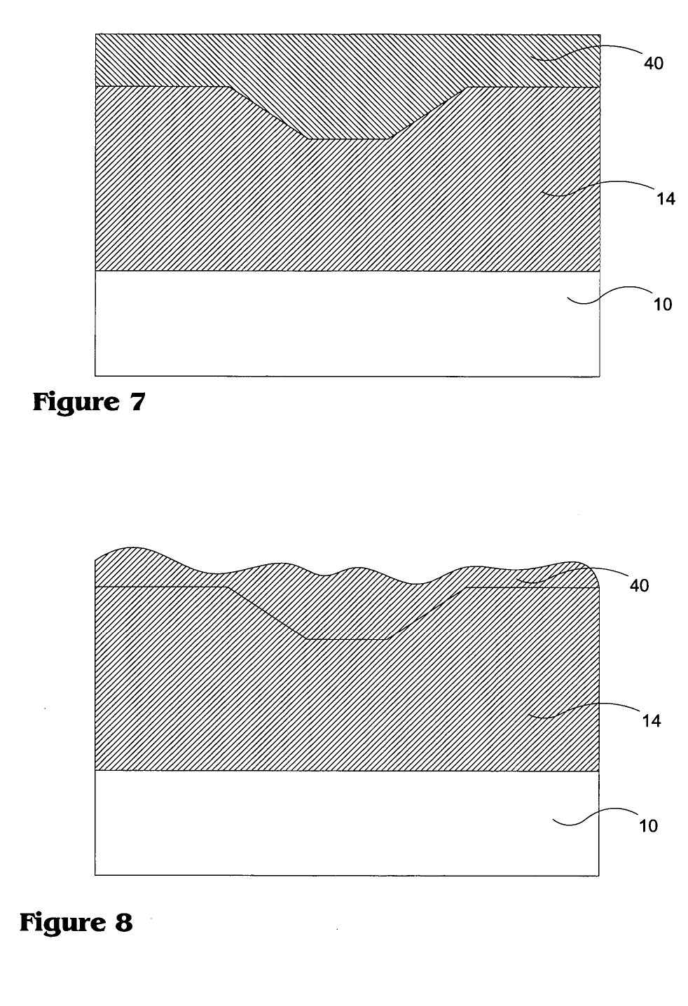

Once the lens shape 32 is completed, a lens material 40 is deposited to fill the lens shape 32, as shown in FIG. 7. The lens material may be deposited by a sputtering process, a CVD process, a spin-on process, or other suitable process. If a spin-on process is used, further smoothing of the upper planar surface may not be necessary. In this case, lenses 20 have been formed. In one embodiment of the present process an anti-reflection (AR) layer 22 is formed over the lenses 20. The anti-reflection layer 22 may be a single layer of material with a refractive index value between that of the lens material 40 and air. In another embodiment, a multilayer AR coating is used. The AR layer 22 may be deposited by a sputtering process, a CVD process, a spin-on process, or other suitable process. If desired, a CMP process may be used to planarize the upper surface of the AR layer 22.

If the lens material 40 is rough, as shown in FIG. 8, a planarizing step is performed. In an embodiment of the present method, a CMP process is used to planarize the lens material 40. Alternatively, a reflow process is used to achieve planarization of the lens material 40. The amount of planarizing is not critical as long as enough each lens remains to achieve improved light collection.

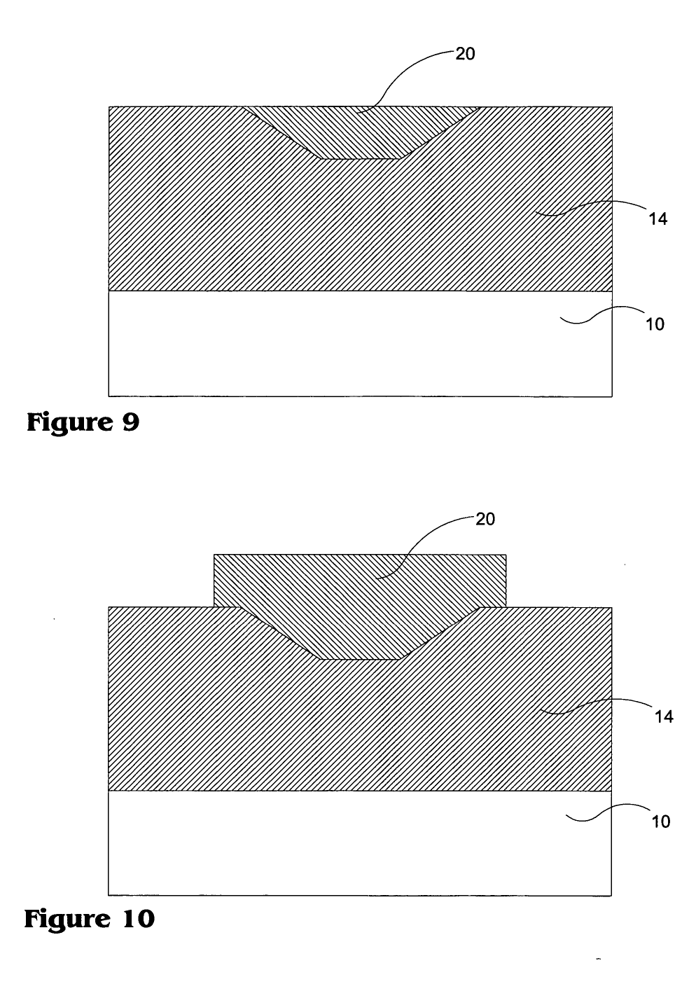

FIG. 9 shows the lens 20 formed by using CMP to polish the lens material. The CMP can stop at the transparent layer 14, or can polish partially into the transparent layer 14.

FIG. 10 shows the lens 20 formed by an alternative method of patterning and etching the lens material 40. The lens material 40 may be left as deposited, or planarized, as discussed above, prior to patterning and etching.

The lens 20 can be covered with an AR coating. For example, FIG. 1 corresponds to the lens structure of FIG. 9 after depositing an AR coating. An AR coating could also be applied to the lens shown in FIG. 10.

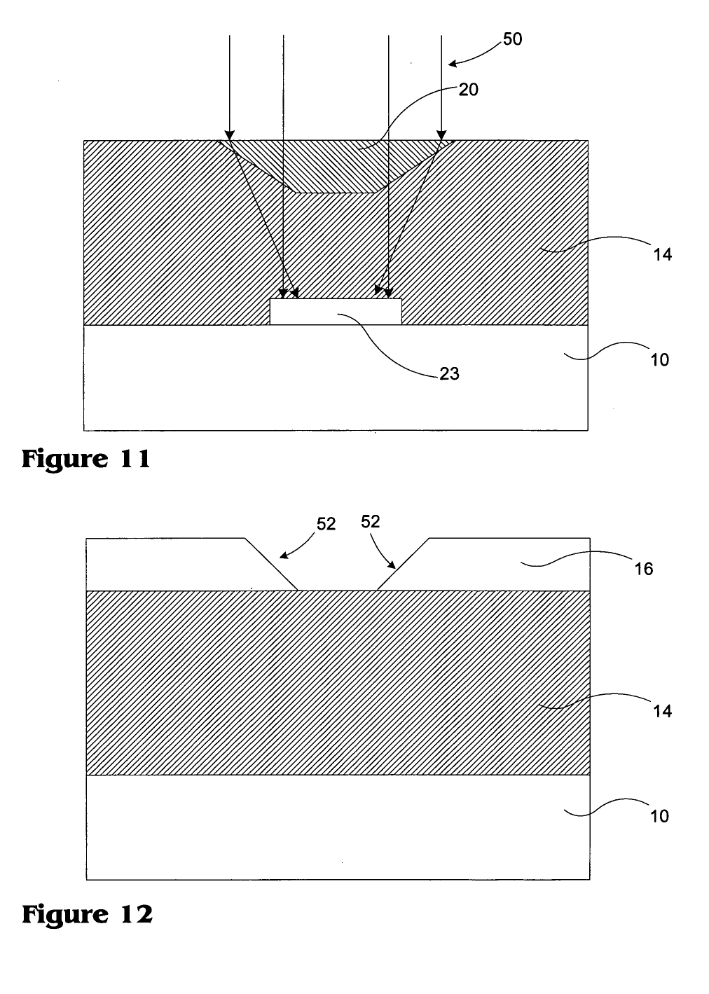

In one embodiment of the present invention, the lens is intended to increase the light intensity impinging on a photodetector 23, as shown in FIG. 11. The photodetector 23 may be for example a pixel within a CCD array. Even if the lens 20 formed using the present method is not spherical or parabolic, it will increase the light intensity impinging on the photodetector by directing the light 50 impinging on the lens 20 toward the photodector 23. It is not necessary for the lens 20 to completely focus the light onto the photodetector 23. In an embodiment of the present microlens structure, wherein it is desirable to concentrate light onto the photodetector 23, the transparent layer 14 will have a lower refractive index than microlenses 20. For example, if the transparent layer 14 has a refractive index of approximately 1.5, the microlenses 20 should have a higher refractive index. If the transparent layer 14 is silicon dioxide or glass, the microlenses 20 are composed of HfO₂, TiO₂, ZrO₂, ZnO₂, or other lens material with a refractive index of approximately 2.

In an alternative embodiment, an optical resin with a refractive index greater than 1.5 may be used to form the microlenses. Optical resin is currently available with a refractive index of approximately 1.7.

In one embodiment of the present process, microlenses 20 are formed overlying the photodetector 23, eliminating the need to form the lenses and then transfer them to the substrate. Accordingly, a substrate having the desired photodetector 23 formed on the substrate is prepared. The transparent layer 14 is formed overlying the photodetector, and the lens 20 is formed.

In an embodiment of the present microlens structure comprising a single material AR layer 22, the AR layer is preferably composed of a material with a refractive index between that of air and the lens material. For example, silicon dioxide, glass, or optical resin may be used over microlenses having a refractive index greater than that of silicon dioxide.

The preceding embodiments utilize a hard mask 16 with an opening 27 having substantially vertical sidewalls, in which case the lens dimensions are determined by the size of the opening 27 and the thickness of the hard mask 16. An additional level of control may be achieved in some embodiments of the present method by modifying the dry etch process to produce an opening 27 with sidewalls 52 having non-vertical sidewalls, as shown in FIG. 12. By reducing the sidewall angle from the 900 corresponding to vertical sidewall, the effective lateral etch rate is increased by a factor of 1 divided by the sine of the angle. So for example, if the sidewalls are at a 60°, the lateral etch rate will increase by a factor of 1.155, or approximately a 15% increase in lateral etch rate. And, if the sidewalls 52 are at 45°, the lateral etch rate will increase by a factor of 1.414, or approximately 40%. By adjusting the sidewall angle the etch time will remain the same, so that the resulting lens will have the same thickness (d), but will have a larger diameter (D).

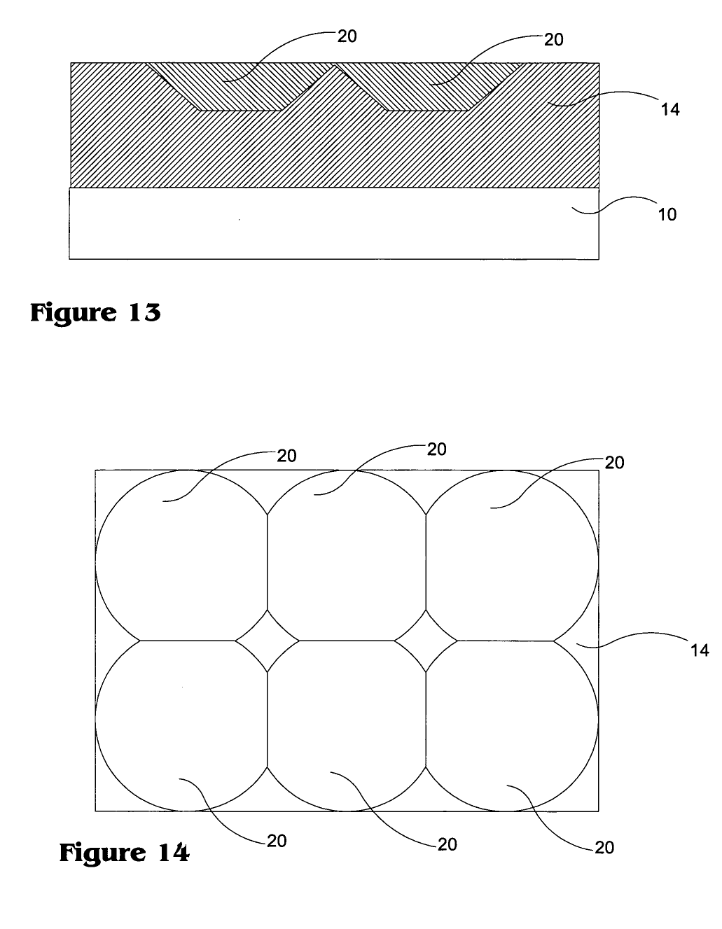

The embodiments of the present method have discussed forming a single lens. However, the embodiments of the present method described above are also suitable for forming a microlens array. FIGS. 13 and 14 show lenses 20 in contact, and possibly overlapping. The ability to etch adjacent lenses until they are in contact increases achievable fill factors. Embodiments of the present method may allow the fill factor to approach 100%. This will increase the amount of light that can be redirected a photodetector, for example. As discussed above, embodiments of the present method are not limited to producing a round, or even a square shape.

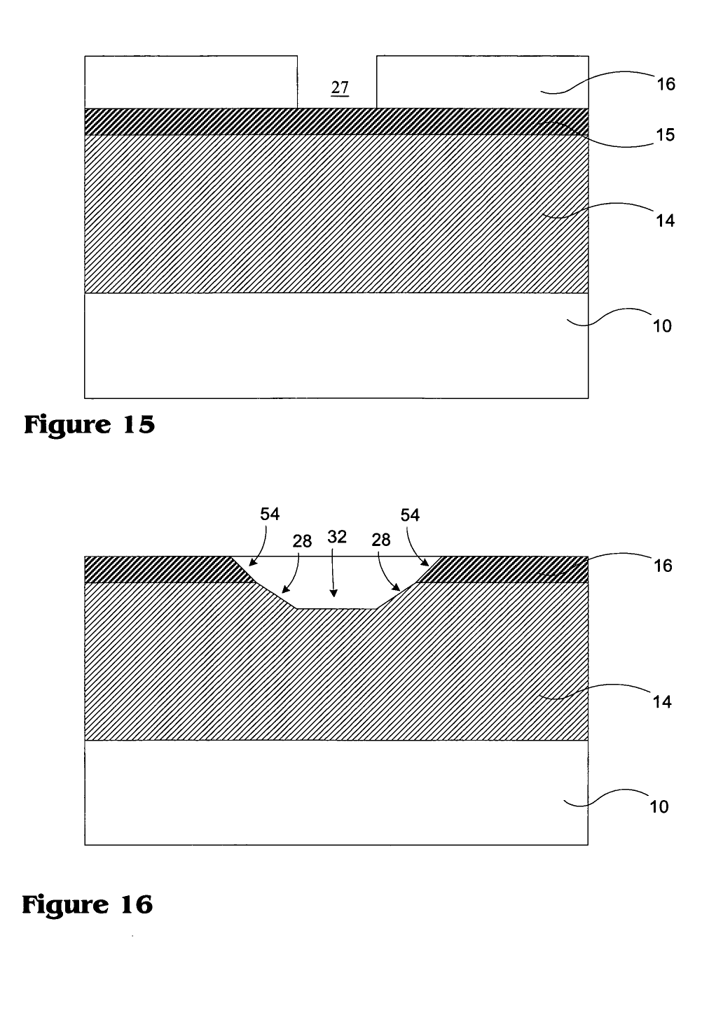

In another embodiment of the present method, the lens shape 32 is modified by providing a multilayer structure. As shown in FIG. 15, a second transparent layer 15 is formed overlying the transparent layer 14, such that it is interposed between the hard mask 16 and the transparent layer 14. The second transparent layer 15, for example, has an etch rate value that is between that of the transparent layer 14 and the hard mask 16. For example, if the transparent layer is thermal oxide, and the hard mask is TEOS oxide, the second transparent layer 15 may be a doped TEOS oxide having a slower etch rate than the undoped TEOS oxide, or a doped thermal oxide having a faster etch rate than the undoped thermal oxide.

FIG. 16 shows the lens shape 32 using the initial multilayer structure shown in FIG. 15. The lens shape has a more circular appearance produced by sidewall regions 54 having a different angle than sidewalls 28.

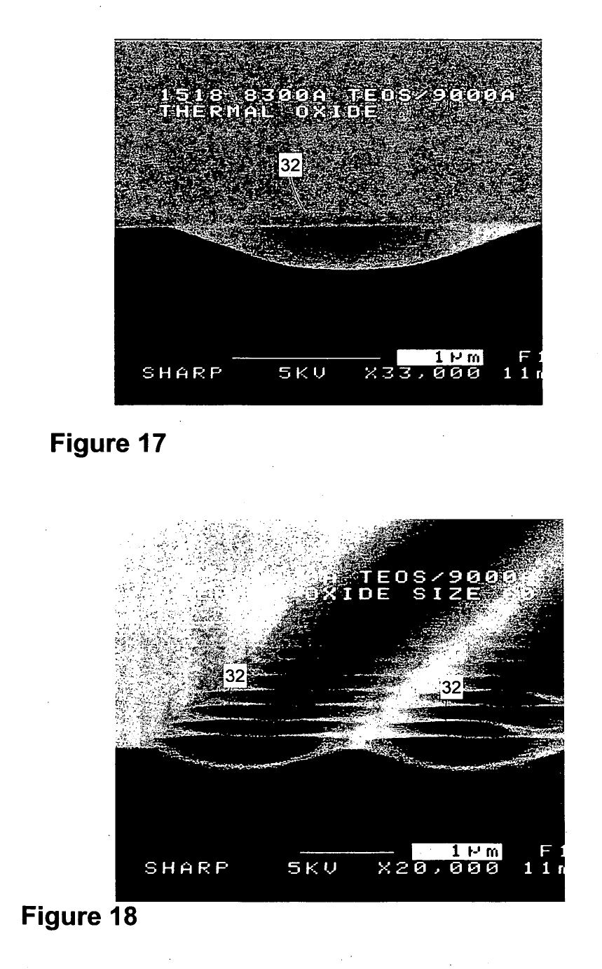

FIG. 17 is an SEM image of a lens shape 32 formed using a layer of TEOS hard mask, which has been completely etched away, overlying a thermal oxide transparent layer. FIG. 18 is an SEM image an array of lens shapes 32.

Although embodiments have been discussed above, the coverage is not limited to any specific embodiment. Rather, the claims shall determine the scope of the invention.

1. A method of forming a microlens structure comprising:
a) providing a transparent material;
b) forming a hard mask overlying the transparent material;
c) patterning an opening in the hard mask; and
d) forming a lens shape by etching the hard mask and the transparent material using an isotropic wet etch, whereby the hard mask is etched laterally to expose a larger area of the underlying transparent layer as the etch proceeds.

2. The method of claim 1, further comprising filling the lens shape with a lens material.

3. The method of claim 1, wherein the transparent material is silicon oxide, or glass.

4. The method of claim 1, wherein the transparent material is an optical resin.

5. The method of claim 3, wherein the isotropic wet etch is a buffered HF etch.

6. The method of claim 2, wherein the lens material has a higher refractive index than the transparent material.

7. The method of claim 3, wherein the lens material comprises HfO₂, TiO₂, ZrO₂, ZnO₂, or optical resin.

8. The method of claim 2, further comprising forming an AR coating overlying the lens material.

9. The method of claim 8, wherein the AR coating is a single layer AR coating.

10. The method of claim 9, wherein the single layer AR coating comprises silicon oxide, glass, or optical resin.

11. The method of claim 2, further comprising planarizing the lens material.

12. The method of claim 11, wherein planarizing the lens material comprises chemical mechanical polishing.

13. The method of claim 11, wherein planarizing comprises reflowing the lens material.

14. The method of claim 1, wherein the isotropic wet etch etches the hard mask faster than the transparent material.

15. The method of claim 14, wherein the hard mask is TEOS oxide and the transparent material is thermal oxide.

16. The method of claim 12, wherein the hard mask is a doped silicon oxide and the transparent material is undoped silicon oxide.

17. The method of claim 1, wherein the opening in the hard mask has non-vertical walls.

18. The method of claim 1, further comprising a second transparent material overlying the transparent material.

19. The method of claim 18, wherein the second transparent material has a faster etch rate than the transparent material.

20. The method of claim 1, wherein the transparent layer is provided overlying a substrate having a photodetector formed thereon.
